(19) United States
(12) Patent Application Publication
(10) Pub. No.: US 2004/0147424 A1
(43) Pub. Date: Jul. 29, 2004

(54) Surfactant mixture

(76) Inventors: Andreas Syldath, Monheim (DE); Anke Eggers, Duesseldorf (DE); Michael Neuss, Koeln (DE); Ansgar Behler, Bottrop (DE)

Correspondence Address: COGNIS CORPORATION, PATENT DEPARTMENT, 300 BROOKSIDE AVENUE, AMBLER, PA, 19002, US

(21) Appl. No.: 10/477,096

(22) PCT Filed: Apr. 27, 2002
(86) PCT No.: PCT/EP02/04695

(30) Foreign Application Priority Data
May 8, 2001 (DE) 101222572

(51) Int. Cl. C11D 17/00

(52) U.S. Cl. 510/421

(57) ABSTRACT

A surface-active composition containing a surfactant mixture having: (a) from about 10 to 45% by weight of an alkyl and/or alkenyl oligoglycoside; and (b) from about 55 to 90% by weight of an alkyl and/or alkenyl oligoglycoside ether carboxylic acid, all weights being based on the weight of the mixture.

### FIELD OF THE INVENTION

This invention relates to a surfactant mixture of alkyl and/or alkenyl oligoglycosides and/or alkyl and/or alkenyl oligoglycoside ether carboxylic acids and to the use of the mixture as an emulsifier or foaming agent.

### PRIOR ART

By virtue of their high dermatological compatibility, alkyl oligoglycosides are used as mild surfactants in a number of surface-active preparations such as, for example, dishwashing detergents and also hair shampoos. A particular disadvantage was that the foams formed in hard water were not stable and that the foaming power of alkyl oligoglycosides was not comparable with that of ether sulfates or other very good foaming agents. In addition, alkyl oligoglycosides on their own show unwanted tackiness which is a disadvantage above all in hair-care applications, for example in shampoos.

Now, the problem addressed by the present invention was to provide surfactant mixtures based on alkyl and/or alkenyl oligoglycosides which would have improved foam properties and of which the foam would remain stable even in hard water. Another problem addressed by the present invention was to reduce the tackiness of alkyl and/or alkenyl oligoglycosides. In addition, the mixtures according to the invention would also have emulsifying properties and would thus be suitable for the production of emulsions.

### DESCRIPTION OF THE INVENTION

The present invention relates to a surfactant mixture containing—based on the active substance content—

(a) 10 to 45% by weight of alkyl and/or alkenyl oligoglycosides and

(b) 55 to 90% by weight of alkyl and/or alkenyl oligoglycoside ether carboxylic acids,

with the proviso that the quantities shown add up to 100% by weight.

It has surprisingly been found that surfactant mixtures which, besides alkyl and/or alkenyl oligoglycosides as their main component, also contain alkyl and/or alkenyl oligoglycoside ether carboxylic acids, preferably mixtures of C_{12/14} alkyl oligoglycosides with an excess of C_{12/14} alkyl oligoglycoside ether carboxylic acids, are comparable to ether sulfates in their foam properties and show high foam volume irrespective of the water hardness factor. In addition, the surfactant mixtures according to the invention, preferably mixtures of C_{12/14} alkyl oligoglycosides with an excess of C_{12/14} alkyl oligoglycoside ether carboxylic acids, show reduced tackiness so that they are particularly suitable for hair care applications. The invention includes the observation that the preparations in question show high compatibility with the skin and mucous membrane. In addition, it has been found that, preferably, alkyl oligoglycoside/alkyl oligoglycoside ether carboxylic acids mixtures based on C_{16/22} fatty alcohol and particularly hydrogenated C_{16/18} fatty alcohol have emulsifying properties and are therefore suitable for the production of w/o and o/w emulsions.

Alkyl and/or Alkenyl Oligoglycosides

The surfactant mixtures according to the invention contain as component (a) alkyl and alkenyl oligoglycosides corresponding to formula (I):

R¹O-[G]ₚ (I)

where R¹ is an alkyl and/or alkenyl group containing 4 to 22 carbon atoms, G is a sugar unit containing 5 or 6 carbon atoms and p is a number of 1 to 10. They may be obtained by the relevant methods of preparative organic chemistry. The synoptic articles by Biermann et al. in Starch/Stärke 45, 281 (1993), B. Salka in Cosm. Toil. 108, 89 (1993) and J. Kahre et al. in SÖFW-Journal No. 8, 598 (1995) are cited as representative of the extensive literature available on this subject.

The alkyl and/or alkenyl oligoglycosides may be derived from aldoses or ketoses containing 5 or 6 carbon atoms, preferably glucose. Accordingly, the preferred alkyl and/or alkenyl oligoglycosides are alkyl and/or alkenyl oligoglucosides. The index p in general formula (I) indicates the degree of oligomerization (DP), i.e. the distribution of mono- and oligoglycosides, and is a number of 1 to 10. Whereas p in a given compound must always be an integer and, above all, may assume a value of 1 to 6, the value p for a certain alkyl oligoglycoside is an analytically determined calculated quantity which is generally a broken number. Alkyl and/or alkenyl oligoglycosides having an average degree of oligomerization p of 1.1 to 3.0 are preferably used. Alkyl and/or alkenyl oligoglycosides having a degree of oligomerization of less than 1.7 and, more particularly, between 1.2 and 1.4 are preferred from the applicational point of view. The alkyl or alkenyl group R¹ may be derived from primary alcohols containing 12 to 22, preferably 12 to 18 and more particularly 12 to 14 and 16 to 18 carbon atoms. Typical examples are lauryl alcohol, myristyl alcohol, cetyl alcohol, palmitoleyl alcohol, stearyl alcohol, isostearyl alcohol, oleyl alcohol, elaidyl alcohol, petroselinyl alcohol, arachyl alcohol, gadoleyl alcohol, behenyl alcohol, erucyl alcohol, brassidyl alcohol and the technical mixtures thereof which may be obtained as described above. Alkyl oligoglucosides based on C_{12/14} coconut oil fatty alcohol and hydrogenated C_{16/18} fatty alcohol having a DP of 1 to 3 are preferred.

Alkyl and/or Alkenyl Oligoglycoside Ether Carboxylic Acids

The surfactant mixtures according to the invention contain as component (b) alkyl and/or alkenyl oligoglycoside ether carboxylic acids corresponding to formula (II):

R²O-[G]_{q}[O(CH₂)ₘCOO⁻X⁺]ₙ (II)

in which R² is an alkyl and/or alkenyl group containing 4 to 22, preferably 12 to 18 and more particularly 12 to 14 and 16 to 18 carbon atoms, G is a sugar unit containing 5 or 6 carbon atoms, q is a number of 1 to 10, m is a number of 1 to 5, n is a number of 1 to 5 and preferably 1 to 3 and X represents alkali metal, ammonium and alkaline earth metal. They may be obtained by the relevant methods of preparative organic chemistry, for example by reaction of alkyl and/or alkenyl oligoglycosides with halocarboxylic acids in alkaline medium in the presence of solvents. The alkyl and/or alkenyl oligoglycoside ether carboxylic acids may be derived from aldoses or ketoses containing 5 or 6 carbon atoms, preferably glucose. Accordingly, the preferred alkyl and/or alkenyl oligoglycoside ether carboxylic acids are alkyl and/or alkenyl oligoglucoside ether carboxylic acids. The index q in general formula (II) indicates the degree of oligomerization (DP), i.e. the distribution of mono- and oligoglycosides, and is a number of 1 to 10. Whereas q in a given compound must always be an integer and, above all, may assume a value of 1 to 6, the value q for a certain alkyl oligoglycoside is an analytically determined calculated quantity which is generally a broken number. Alkyl and/or alkenyl oligoglycoside ether carboxylic acids having an average degree of oligomerization q of 1.1 to 3.0 are preferably used. Alkyl and/or alkenyl oligoglycoside ether carboxylic acids having a degree of oligomerization of less than 1.7 and, more particularly, between 1.2 and 1.4 are preferred from the applicational point of view. The alkyl or alkenyl group R² may be derived from primary alcohols containing 4 to 11 and preferably 8 to 10 carbon atoms. Typical examples are butanol, caproic alcohol, caprylic alcohol, capric alcohol and undecyl alcohol and the technical mixtures thereof obtained, for example, in the hydrogenation of technical fatty acid methyl esters or in the hydrogenation of aldehydes from Roelen's oxosynthesis. The alkyl or alkenyl group R² is derived in particular from primary alcohols containing 12 to 22, preferably 12 to 18 and more particularly 12 to 14 and 16 to 18 carbon atoms. Typical examples are lauryl alcohol, myristyl alcohol, cetyl alcohol, palmitoleyl alcohol, stearyl alcohol, isostearyl alcohol, oleyl alcohol, elaidyl alcohol, petroselinyl alcohol, arachyl alcohol, gadoleyl alcohol, behenyl alcohol, erucyl alcohol, brassidyl alcohol and technical mixtures thereof which may be obtained as described above. Alkyl oligoglucoside ether carboxylic acids based on hydrogenated C_{12/14} coconut oil fatty alcohol and C_{16/18} fatty alcohol having a DP of 1 to 3 are preferred.

In addition, the alkyl and/or alkenyl oligoglycoside ether carboxylic acids are preferably derived from carboxylic acids, salts or esters thereof in which m is a number of 1 to 5, preferably 2 to 4 and more particularly 1 and 2, n is a number of 1 to 5 and preferably 1 to 3 and X represents alkali metal, ammonium and alkaline earth metal, preferably alkali metal and more particularly sodium. Suitable carboxylic acids, salts or esters thereof are any of the compounds known to the expert, preferably acetic acid, salts, more particularly sodium or potassium salts, or esters thereof, preferably containing 1 to 4 carbon atoms.

In a preferred embodiment of the invention, the alkyl and/or alkenyl oligoglycoside ether carboxylic acids may be obtained by reaction of an aqueous solution of alkyl and/or alkenyl oligoglycosides (at most 70% by weight solution, based on the active substance content) under nitrogen with w-halocarboxylic acid, a salt or ester thereof, preferably potassium or sodium chloroacetate (MCA) in the presence of alkali, for example alkali metal hydroxides or alkali metal carbonates, at temperatures of 50 to 100° C. The alkyl and/or alkenyl oligoglycoside is preferably reacted with the ω-halocarboxylic acid, salts or ester, preferably potassium or sodium monochloroacetate (MCA), in a molar ratio of 1:0.5 to 1:5 and preferably in a molar ratio of 1:1 to 1:3. In addition, a molar ratio of alkali to ω-halocarboxylic acid, salt or ester of 1:0.5 to 1:1.5 and preferably 1:1.1 is preferably selected. The reaction of C_{12/14} alkyl and/or alkenyl oligoglycosides is preferably carried out in the absence of organic solvents. C_{16/18} alkyl and/or alkenyl oligoglycoside ether carboxylic acids are preferably prepared in the presence of C_{16/18} fatty alcohols, more particularly 1,2-propylene glycol.

In another process step, water may be removed from this reaction product by conventional drying processes, preferably freeze drying, so that a dry powder of the surfactant mixture of alkyl and/or alkenyl oligoglycoside ether carboxylic acids and alkyl and/or alkenyl glycosides with a high active substance content and a residual water content of at most 5% by weight, preferably at most 3% by weight and more particularly at most 1% by weight, based on the dried product, is obtained.

Commercial Applications

One particular embodiment of the invention is characterized by the use of surfactant mixtures which contain the alkyl and/or alkenyl oligoglycosides and the alkyl and/or alkenyl oligoglycoside ether carboxylic acids in a ratio by weight of 10:90 to 45:55 and preferably 20:80 to 40:60.

The surfactant mixtures according to the invention may be adjusted to any concentration by addition of water. The water content may be from 20 to 80% by weight and is preferably in the range from 25 to 60% by weight and more particularly in the range from 30 to 50% by weight.

The surfactant mixtures according to the invention may be used in surface-active preparations in quantities of 0.05 to 40, preferably 0.5 to 25 and more particularly 2.5 to 10% by weight, based on the active substance content.

In the context of the invention, surface-active preparations are preferably laundry and dishwashing detergents, cleaners and cosmetic and/or pharmaceutical preparations, more particularly cosmetic and/or pharmaceutical preparations. These surface-active preparations may contain pearlizing waxes, consistency factors, thickeners, superfatting agents, stabilizers, silicone compounds, fats, waxes, lecithins, phospholipids, antioxidants, deodorants, antiperspirants, antidandruff agents, swelling agents, tyrosine inhibitors, hydrotropes, solubilizers, preservatives, perfume oils, dyes, surfactants and other ingredients typically encountered, for example, in laundry detergents, dishwashing detergents and cleaners as further auxiliaries and additives. Cosmetic and/or pharmaceutical preparations in the context of the invention are preferably oral hygiene and dental care preparations, hair shampoos, hair lotions, foam baths, shower baths, creams, gels, lotions, alcoholic and aqueous/alcoholic solutions and emulsions.

The mixtures according to the invention may preferably be used in the surface-active preparations as foaming agents or as emulsifiers. Accordingly, mixtures of alkyl and/or alkenyl oligoglycosides corresponding to formula (I) and alkyl and/or alkenyl oligoglycoside ether carboxylic acids corresponding to formula (II), in which the alkyl or alkenyl groups R¹ and R² independently of one another are derived from primary alcohols containing 16 to 18 carbon atoms and have degrees of oligomerization q and p independently of one another of 1 to 3 (more particularly hydrogenated C_{16/18} fatty alcohol), are preferably used as emulsifiers.

Surfactant mixtures of alkyl and/or alkenyl oligoglycosides corresponding to formula (I) and alkyl and/or alkenyl oligoglycoside ether carboxylic acids corresponding to formula (II), in which the alkyl or alkenyl groups R¹ and R² independently of one another are derived from primary alcohols containing 12 to 14 carbon atoms and have degrees of oligomerization q and p independently of one another of 1 to 3 (more particularly C_{12/14} fatty alcohol), are preferably used as a surface-active agent, i.e. as a foaming agent. Accordingly, the present invention also relates to the use of the mixtures according to the invention as an emulsifier or as a foaming agent.

Typical cosmetic and/or pharmaceutical cleaning preparations preferably have the following composition, based on the active substance content:

(a) 0.05 to 15, preferably 0.5 to 10 and more particularly 2.5 to 7.5% by weight of a mixture of (a1) a C₆₋₁₄ and preferably C₁₂₋₁₄ alkyl and/or alkenyl oligoglycoside and (a2) a C₆₋₁₄ and preferably C₁₂₋₁₄ alkyl and/or alkenyl oligoglycoside ether carboxylic acid,

(b) 0.05 to 15, preferably 0.5 to 10 and more particularly 2.5 to 7.5% by weight of betaines and optionally

(c) 0 to 15, preferably 0.5 to 10 and more particularly 2.5 to 7.5% by weight of other anionic surfactants,

with the proviso that the quantities mentioned add up to 100% by weight, optionally with other auxiliaries and additives.

Typical liquid laundry and dishwashing detergents and cleaners preferably have the following composition, based on the active substance content:

(a) 2.5 to 30, preferably 7 to 25 and more particularly 10 to 20% by weight of a mixture of (a1) a C₆₋₁₄ and preferably C₁₂₋₁₄ alkyl and/or alkenyl oligoglycoside and (a2) a C₆₋₁₄ and preferably C₁₂₋₁₄ alkyl and/or alkenyl oligoglycoside ether carboxylic acid,

(b) 0.05 to 15, preferably 0.5 to 10 and more particularly 2.5 to 7.5% by weight of betaines and optionally

(c) 2.5 to 30, preferably 7 to 25 and more particularly 10 to 20% by weight of other anionic surfactants,

with the proviso that the quantities mentioned add up to 100% by weight, optionally with other auxiliaries and additives.

Typical cosmetic and/or pharmaceutical emulsions preferably have the following composition, based on the active substance content:

(a) 0.05 to 15, preferably 0.5 to 10 and more particularly 1 to 5% by weight of a mixture of (a1) a C₁₆₋₂₂ and preferably C₁₆₋₁₈ alkyl and/or alkenyl oligoglycoside and (a2) a C₁₆₋₂₂ and preferably C₁₆₋₁₈ alkyl and/or alkenyl oligoglycoside ether carboxylic acid,

(b) 3 to 30, preferably 5 to 20 and more particularly 7 to 15% by weight of oil components and optionally

(c) 0.5 to 20 and preferably 2.5 to 10% by weight of consistency factors, with the proviso that the quantities mentioned add up to 100% by weight, optionally with other auxiliaries and additives.

### EXAMPLES

In order to investigate foaming behavior, water-containing surfactant mixtures were prepared and tested for foam volume to DIN 53 902, Part 1 (0.2 g active substance/I; 40° C.; 15° dH; pH 6.0). In this test, the foam is produced by beating of the liquid sample for 30 seconds in a gas jar with a horizontal perforated plate fixed to a handle. The foam volume formed is measured immediately after the end of beating and 5, 10 and 20 minutes thereafter. Tackiness was evaluated by a panel of 6 examiners on a scale of ++(very tacky), +(slightly tacky) to −(non-tacky) using dried (water-free) samples. The results are set out in Tables 1 and 2. The following surfactants were used (quantities in % by weight active substance). Stability was visually evaluated after 2 weeks at 40° C.: separation and inhomogeneity (unstable), homogeneous (stable).

A) C_{12/14} alkyl polyglucoside (Plantacare 1200 UP, Cognis Deutschland GmbH)

B) C_{12/14} alkyl polyglucoside methyl carboxylate

TABLE 1
Foam measurements of aqueous surfactant solutions

| | Ratio by weight of A to B | | | | |
|---|---|---|---|---|---|
| | 20:80 | 40:60 | 45:55 | 70:30 | 100:0 |
| Foam height [ml] | 1 | 2 | 3 | C1 | C2 |
| Immediately | 620 | 560 | 590 | 450 | 300 |
| After 5 mins. | 620 | 560 | 590 | 450 | 300 |
| After 10 mins. | 620 | 550 | 590 | 440 | 290 |
| After 20 mins. | 610 | 540 | 570 | 420 | 280 |

TABLE 2
Tackiness of the surfactant mixture - quantities in %
by weight active substance

| Composition | 1 | 2 | 3 | C1 | C2 |
|---|---|---|---|---|---|
| C_{12/14} alkyl polyglucoside | 45 | 40 | 30 | 100 | 70 |
| C_{12/14} alkyl polyglucoside methyl carboxylate | 55 | 60 | 70 | − | 30 |
| Tackiness | − | − | − | ++ | + |

TABLE 3
Emulsions containing the surfactant solutions according to the
invention - quantities in % by weight active substance

| Composition | 1 | 2 | 3 | 4 | 5 | 6 | 7 |
|---|---|---|---|---|---|---|---|
| APG carboxylate 1 | 2.0 | — | — | 2.0 | 2.0 | 1.0 | — |
| APG carboxylate 2 | — | 2.0 | — | — | — | — | 1.0 |
| APG carboxylate 3 | — | — | 2.0 | — | — | 2.0 | 2.0 |
| Cetearyl alcohol | 5.0 | 5.0 | 5.0 | 6.0 | 6.0 | 4.0 | 4.0 |
| Dicaprylyl Ether | 4.0 | 4.0 | 4.0 | — | — | — | — |
| Coco-Caprylate/Caprate | 7.0 | 7.0 | 7.0 | 6.0 | 10.0 | 20.0 | 4.0 |
| Capric/Caprylic | 5.0 | 5.0 | 5.0 | 10.0 | 6.0 | 10.0 | 12.0 |
| Triglyceride | | | | | | | |
| Benzophenone-3 | — | — | — | 2.0 | 2.0 | 2.0 | 2.0 |
| Octyl Methoxycinnamate | — | — | — | 7.5 | 7.5 | 7.5 | 3.0 |
| Titanium oxide | — | — | — | — | — | — | 3.5 |
| Zinc oxide | — | — | — | — | 6.0 | — | 3.5 |
| Glycerol | 3.0 | 3.0 | 3.0 | 5.0 | 5.0 | 5.0 | 5.0 |
| Water | to 100 | | | | | | |
| Stability, 40° C., 2 weeks | Stable | Stable | Stable | Stable | Stable | Stable | Stable |

1: C_{16/18} alkyl polyglycoside/C_{16/18} alkyl polyglycoside methyl carboxylate, ratio 45:55
2: C_{16/18} alkyl polyglycoside/C_{16/18} alkyl polyglycoside methyl carboxylate, ratio 20:80
3: C_{16/18} alkyl polyglycoside/C_{16/18} alkyl polyglycoside methyl carboxylate, ratio 40:60

1. A surfactant mixture containing—based on the active substance content—
(a) 10 to 45% by weight of alkyl and/or alkenyl oligoglycosides and
(b) 55 to 90% by weight of alkyl and/or alkenyl oligoglycoside ether carboxylic acids,
with the proviso that the quantities shown add up to 100% by weight.

2. A mixture as claimed in claim 1, characterized in that alkyl and/or alkenyl oligoglycosides corresponding to formula (I):
R¹O-[G]ₚ (I)
where R¹ is an alkyl and/or alkenyl group containing 4 to 22 carbon atoms, G is a sugar unit containing 5 or 6 carbon atoms and p is a number of 1 to 10,
are used.

3. A mixture as claimed in claims 1 and/or 2, characterized in that alkyl and/or alkenyl oligoglycosides corresponding to formula (I), where R¹ is an alkyl and/or alkenyl group containing 12 to 18 carbon atoms, G is a sugar unit containing 5 or 6 carbon atoms and p is a number of 1 to 10, are used.

4. A mixture as claimed in at least one of claims 1 to 3, characterized in that alkyl and/or alkenyl oligoglycoside ether carboxylic acids corresponding to formula (II):
R²O-[G]_{q}[O(CH₂)ₘCOO⁻X⁺]ₙ (II)
in which R² is an alkyl and/or alkenyl group containing 4 to 22 carbon atoms, G is a sugar unit containing 5 or 6 carbon atoms, q is a number of 1 to 10, m is a number of 1 to 5, n is a number of 1 to 3 and X represents alkali metal, ammonium and alkaline earth metal,
are used.

5. A mixture as claimed in at least one of claims 1 to 4, characterized in that alkyl and/or alkenyl oligoglycoside ether carboxylic acids corresponding to formula (II), in which R² is an alkyl and/or alkenyl group containing 12 to 18 carbon atoms, G is a sugar unit containing 5 or 6 carbon atoms, q is a number of 1 to 10, m is a number of 1 to 5, n is a number of 1 to 3 and X represents alkali metal, ammonium and alkaline earth metal, are used.

6. A mixture as claimed in at least one of claims 1 to 5, characterized in that components (a) and (b) are used in a ratio by weight of 20:80 to 40:60.

7. A preparation containing 0.05 to 40% by weight—based on the active substance content—of the surfactant mixture claimed in claim 1.

8. The use of the mixture claimed in claim 1 as an emulsifier.

9. The use of the mixture claimed in claim 1 as a foaming agent.
